(19) United States
(12) Patent Application Publication
(10) Pub. No.: US 2008/0269948 A1
(43) Pub. Date: Oct. 30, 2008

(54) Hybrid control system for collectives of evolvable nanorobots and microrobots

(75) Inventor: Neal Solomon, Oakland, CA (US)

Correspondence Address: Neal Solomon, PO Box 21297, Oakland, CA, 94620, US

(73) Assignee: Solomon Research LLC, Oakland, CA (US)

(21) Appl. No.: 11/985,050

(22) Filed: Nov. 13, 2007

Related U.S. Application Data
(60) Provisional application No. 60/865,605, filed on Nov. 13, 2006.
(60) Provisional application No. 60/912,133, filed on Apr. 16, 2007.
(60) Provisional application No. 60/941,600, filed on Jun. 1, 2007.
(60) Provisional application No. 60/958,466, filed on Jul. 7, 2007.

(51) Int. Cl. G06F 19/00

(52) U.S. Cl. 700/245; 901/50

(57) ABSTRACT

A system is described for the organization and self-assembly of collectives of nanorobots (CNRs) and microrobots using nano evolvable hardware (N-EHW) mechanisms for biological and electronics applications. CNRs combine to organize into complex geometrical structures and reaggregate their structural configurations in real time as they adapt to the feedback of evolving environmental conditions to solve complex optimization problems.

### CROSS-REFERENCES TO RELATED APPLICATIONS

The present application claims the benefit of priority under 35 U.S.C. § 119 from U.S. Provisional Patent Application Ser. No. 60/865,605, filed on Nov. 13, 2006, U.S. Provisional Patent Application Ser. No. 60/912,133, filed Apr. 16, 2007, U.S. Provisional Patent Application Ser. No. 60/941,600, filed Jun. 1, 2007 and U.S. Provisional Patent Application No. 60/958,466, filed Jul. 7, 2007, the disclosures of which are hereby incorporated by reference in their entirety for all purposes.

### FIELD OF THE INVENTION

The present invention involves nanotechnology, nanoelectromechanical systems (NEMS) and microelectromechanical systems (MEMS). The invention also deals with collective robotics (CR) on the nano-scale, or collective nano-robotics (CNR) and nano-scale mechatronics control theory. The invention deals with bio-inspired computing systems, including immunocomputing. The field of evolvable hardware (EHW) is extended from electronics semiconductors, viz., FPGAs, to nanotechnology by using aggregation processes of combining collectives of nanorobots. Applications of nano-evolvable hardware (N-EHW) include bio-medical and electronics techniques.

### BACKGROUND OF THE INVENTION

Since 1996, researchers at MIT have developed the concept of “amorphous computing” which is applicable to nanorobotics collectives. Amorphous computing architectures involve large numbers of identical parallel computer processors that have local environmental interactions. This network computing architecture uses swarm intelligence algorithms (particle swarm optimization, ant colony optimization and stochastic diffusion search) to coordinate the behaviors of equivalent computational entities to achieve a goal. While amorphous computing borrows from grid computing models, it is limited to programmable, not reprogrammable, functions. Further, the model only uses identical computing devices, much like ants or bees in colonies or hives. Finally, the system only uses local control to interact with the nearest neighbors.

Researchers at the Institute for Robotics and Intelligent Systems at USC have developed a system for collective microrobots by organizing robots to cooperate using local rules by using computer simulations.

Since 2001, researchers at Carnegie Mellon University have developed a system for “synthetic reality” called “claytronics” which uses “programmable matter” to self-organize into different shapes. This novel system develops novel hardware and software to organize three dimensional shapes. Claytronics uses components called “catoms” (claytronic atoms) that adhere to each other and interact in three dimensions. The claytronics system combines ideas from amorphous computing and reconfigurable robotics. However, to date, the goal of organizing millions of micro-robotic entities has not been achieved.

The field of collective robotics (CR) has a literature that involves organized systems of groups of robots for specific applications. These applications include factory automation, reconnaissance, remote sensing, traffic coordination, security and hazard management.

One way to organize CR systems is to develop a hybrid control system. In one example of a hybrid control system, central control is combined with elements of behavior-based control. In another example, a multi-agent system (MAS) is integrated with a multi-robotic system (MRS). These systems use elements of evolutionary computation in order for the system to autonomously compute the environmental feedback that must be overcome to achieve a goal.

CR systems are examples of advanced hardware systems that employ self-organizational capacities analogous to ones in nature. The bio-inspired computing literature has emerged to identify artificial methods to emulate, and surpass, specific naturally occurring biological systems. For example, the protein network that allows communication between living cells, the neural plasticity of the human brain or the adaptive operation of the human immune system are examples of biological system capabilities that are emulated by artificial systems in computer science.

Several metaheuristic computational methods are used to guide processes to solve complex combinatorial optimization problems. These bio-inspired computing models include local search (scatter search, tabu search and adaptive memory programming), swarm intelligence (ant colony optimization, particle swarm optimization and stochastic diffusion search), genetic algorithms and artificial immune systems (immunocomputing). Local search is optimally applied to cellular automata solutions, while swarm intelligence and AIS are optimally applied to emergent behaviors.

One of the most prominent recent examples of bio-inspired computing lies in the field of immunocomputing. Computer systems are organized to emulate the humoral and adaptive human immune system operations. In the case of the humoral immune system, a cascade of proteins is emulated in order to accomplish a specific task. In the case of the adaptive immune system, a novel pathogen will stimulate a reaction by specific antibodies which will attack the pathogen and learn to attack similar future pathogens. This process provides a learning and adaptive component that is useful in computational processes that deal with accomplishing goals in the context of feedback from uncertain and indeterministic environments.

In the development of collective robotics at the nano scale, however, there are distinctive features that distinguish the system from the macro scale. For example, collective nanorobotics (CNR) has substantial resource constraints, including computation and communications resource limitations. In order for a CNR to exhibit self-organization capabilities, the system must demonstrate artificial intelligence for autonomous behaviors. Hence it is necessary to develop a novel system for efficient AI that optimizes computation hardware and software resources. This research stream is still evolving.

The field of evolvable hardware (EHW) is divided into two areas: electronics and robotics. In electronics, the main uses of EHW are in field programmable gate arrays (FPGAs). In robotics, EHW is applied to robots that transform their physical structure by adding or transforming parts. In the context of extending EHW to the nanoscale, there are numerous problems to overcome. Particularly in applications involving biology or medicine, the application of EHW to nanorobotics presents a range of interesting challenges.

### Problems that the Present System Solves

There are several classes of problem that the present system addresses. In some cases, combinatorial optimization problems require the identification of a complex arrangement of nanorobotic parts to be assembled and reassembled in a particular order. Another class of problems involves environmental interaction with a CNR system. In order to achieve a goal in an evolving environment, key constraints must be satisfied that require identifying environmental change.

These complex problems are grouped as multi-objective optimization problems (MOOPs) in which there are multiple choices between competing goals. Some of these MOOPs will take the form of temporal sequences in which the solution requires solving a succession of micro goals. The realization of specific thresholds in a process is necessary prior to pursuing the next goal in the sequence. Such contingent phases in a process are required in order for the CNR system to interact at each stage of environmental feedback.

In order to solve critical problems at the molecular biology scale, methods need to be delineated in which CNRs aggregate together to form specific evolvable structures.

The present system focuses on applications in the biological and medical domains. In the biological domain, one problem involves producing CNR teams that aggregate into particular geometric architectures to emulate the functioning of proteins. It is necessary to find ways to identify, mask and precisely copy proteins in order to imitate their structure and behaviors. Specifically, it is necessary to find ways to use the CNRs in order to activate or deactivate particular genes by using the facsimile proteins as keys to induce a set of behaviors. In addition, the present system will use CNRs that are organized to emulate proteins in order to block DNA functioning as well as to block enzymes from functioning.

Finally, it is necessary to find a way to identify CNR locations and activities along a series of pathways of trajectories. This method allows the coordination and integration of a collective of nanorobots as they solve problems.

### SUMMARY OF THE INVENTION

The present system autonomously organizes groups of nanorobot and microrobot collectives for specific biological or electronics applications. The CNRs take on independent team behaviors similar to a division of labor, with specialists performing particular functions at key times to accomplish a goal more efficiently.

The evolvability and structural transformability of the CNR groups is accomplished via interaction with an evolving environment. The specific nanorobots combine in order to create structures that meet environmental goals.

The process of forming into a specific structure, like a protein formed by a combination of amino acids, will continue to modify the CNRs' aggregate geometric structure in order to transform the configuration of the CNR group to satisfy key evolving environmental constraints. In order to solve particular evolving environmental problems, several CNR teams will compete to achieve a goal, thereby stimulating multiple options rather than limiting the process to a single opportunity to solve a problem.

The aggregation and reaggregation of CNRs into specific transforming geometric structures resembles evolvable hardware (EHW). Particularly as the evolving environment changes, the nano evolvable hardware (N-EHW) assembly comprised of CNRs transforms.

The development of an evolutionary system for CNRs creates a cognitive system to emulate self-organization processes in which the system autonomously reorganizes in relation to a changing and uncertain environment in order to achieve a goal. In one approach, the nanorobotic collective facilitates cognitive computing in extensible geometric space by employing reprogrammable integrated circuits that change their topological structure and allow nanorobots in the collective to cooperate to solve optimization problems in order to reconfigure the structure of the collective on-demand.

The CNR hybrid control system uses advanced computational and communications resources. The computational resources are structured into single nanorobot, local network and external computer capabilities. The CNR hybrid control system continuously modulates between the most efficient available computer function. By using efficient AI, software and communications systems, the CNRs operate robustly.

These processes are applied to specific biological and electronics problems. In biology, the CNRs emulate proteins and initiate or block genetic behaviors, such as the functional operation of particular genes. In particular, intracellular mechanisms of RNA transcription are blocked using the present system.

There are a number of genetic diseases, including various neoplasties, metastatic processes, mechanisms of cellular degeneration and immunological functional operations to which the present system is targeted.

The present system is also used for electronics applications. In an additional embodiment, the system is applied to micro-scale robotics systems.

### ADVANTAGES OF THE PRESENT INVENTION

There are a number of advantages of the present system. The present system provides methods and techniques to apply CNRs to biological or electronics applications.

The present system provides ways to develop on-demand self-assembly and reaggregation processes at the nano- and micro-scale in order to solve important biological or electronics problems.

In biology, the system identifies and emulates natural structures, such as proteins or cells, by combining CNRs into micro-assemblies to achieve goals in an evolving biological environment.

Finally, the present system presents a way to target specific cellular regions with CNRs in order to solve particular intracellular problems.

(I) Nano Evolvable Hardware (N-EHW)

Heretofore, evolvable hardware (EHW) has been restricted to two main types: (a) restructuring semiconductor gates embodied in field programmable gate arrays (FPGAs) which shift from one application specific integrated circuit (ASIC) position to another in order to optimize efficiency, particularly useful in uncertain environments for the purpose of rapid prototyping and (b) restructuring, primarily additive robotic equipment, used for manufacturing or mobile sensing. A third, related application of EHW can be made to collective robotics in which multiple robots combine to constitute a system of collective biodynotics whereby the aggregated robotic entities emulate biologically evolved entities, such as insects, in order to solve problems in an evolving environment.

However, an additional category of EHW is developed in the present invention, one that focuses on nano- and micro-scale robotic devices. N-EHW devices combine multiple CNRs into a specific geometrical structure on-demand in order to solve problems in an evolving micro-environment such as intra-cellular behaviors.

(1) Self-Assembly of Nano Evolvable Hardware (N-EHW)

Collectives of nano-robots (CNRs) are nano-scale robots that contain nano-scale computation and communications capability. These CNRs work together to perform specific goals and to solve problems in micro-scale environments such as in vivo or in vitro molecular biology or in electronics applications. The CNRs work together by using software agents which exchange information, model and present solutions to problems and employ specific functional capabilities.

The present invention goes a step beyond the main CNR system by providing methods for the CNRs to combine and produce a form of nano evolvable hardware (N-EHW). These self-configuring hardware apparatuses are nano-scale intelligent robotic devices that aggregate into specific geometric shapes in non-deterministic environments.

The present invention thus presents an artificial synthetic molecular self-assembly mechanism.

(2) Reaggregation Process of Nano Evolvable Hardware (N-EHW)

The CNRs work together cooperatively on teams in order to form into specific structures; these structures are either pre-determined or organized on-demand. After the initial configuration of the N-EHW is completed, the process will continue in an evolving environment in which the CNR cooperative addresses demands to reconfigure into new geometric shapes in order to solve complex problems. The multi-phasal progression of transformation of N-EHWs illustrates a form of self-organization. By restructuring their configurations, the CNRs activate novel functions in order to solve evolving problems. At each successive stage of the progress of the N-EHW process, the system obtains and assimilates new information about the changing situation in the environment and adapts to the changes.

In order to adapt to the changing environment, the N-EHW apparatus modulates the supply of CNR robot components at precise phases in the transformational process.

In one embodiment, the CNRs will “pre-make” or organize a specific N-EHW structure en-route to solve a particular problem as the N-EHW assembly receives environmental feedback and then continue to restructure at the location of the problem in order to continue to solve it.

Reaggregation behaviors of N-EHW engage in a continuous transformation process contingent on environmental feedback and change. Specifically, the N-EHW collection of reaggregating nanorobots interacts with, and adapts to, their evolving environment.

In order to perform these complex dynamic procedures, the N-EHW system comprised of CNRs generates or adds parts to the main evolving structures in order to add utility.

The reaggregation process of the N-EHW system is constantly solving geometrically oriented combinatorial optimization problems in order to identify the precise locations of CNRs in a self-assembled, and evolving, apparatus.

Examples of specific niche applications that use N-EHW are (a) molecular biology, (b) micro-electronics and nano-electronics systems and (c) sensors in control systems.

An example of the use of N-EHW in molecular biology is to perform specific functions in intracellular systems in vitro or in vivo. Specifically, the system is useful in order to create artificial synthetic assemblies to combine artificial amino acid or peptide chains on-demand into pre-ordered proteins. However, the system also reconfigures its assembly structure into new proteins by using the same artificial amino acid parts.

In one embodiment, the artificial amino acid parts are pre-ordered to easily assemble into a particular pre-arranged protein structure. In another embodiment, a typology of protein structures are organized by protein families in order for the N-EHW comprised of CNRs to restructure into pre-ordered proteins on-demand as the environment changes.

(3) Collective Nanorobotic System with Intelligent Reaggregation Process for Adaptive Geometric Configuration

Because the system has social intelligence, it is able to continuously reorganize the geometric configuration of the CNR. This process of continuous reorganization is a form of reaggregation. The combined spatial configuration of groups of nanorobots is reordered contingent on environmental stimuli and feedback mechanisms. As the CNR seeks to solve a problem, it engages in a process of continuous restructuring of its extensible geometric structure in order to continually adapt to its changing environmental situation.

After automatically structuring into a particular initial spatial configuration, the CNR shifts its binding mechanism to reassemble into new configurations at further stages in the process of solving a problem. In a case where protein function is emulated, for example, the CNR discovers that it needs to change its geometrical shape to accomplish a goal, and then activates the structural transformation. In the context of a biological environment, one situation may call for operation of the CNR by mimicking a specific protein structure with one unique functional operation in one event and a change to another structure of protein with another function in another event. By developing a system for continually reconfigurable protein patterns, the present invention creates a novel “smart protein” mechanism that will modify shapes to solve problems in various real-time situations.

(4) Collective Nanobiodynotics for Macro Geometric Nanorobotic Transformation

The field of biodynotics seeks to organize individual structural entities into complex transformable configurations to emulate biological entities. Collective biodynotics is the field of organizing groups of robotic entities into robotic shapes or combinations of robotic shapes to emulate biological entities.

The present invention creates the field of collective nanobiodynotics by providing methods to combine groups of nano-scale robotic entities into functional entities that emulate micro-biological behaviors.

The system of collective nanobiodynotics coordinates multiple CNR teams in order to organize into specific device configurations in real time. These teams are organized to work together cooperatively to accomplish a task, for instance, by using functional specialists in a division of labor, or organized to compete in order to achieve a goal.

Nanorobots are combined into unique geometrical shapes. This feature of CNRs creates a transformable hardware system that emulates virtually any extensible spatial configuration. By using collectives of nanorobots, this system is organized autonomously and the structural transformation process continuously self-organizes. The use of CNRs for this process makes it possible for structural conversion to activate a functional conversion. This nanobiodynotics system has numerous applications.

Underlying the collective nanobiodynotics system is the notion that smaller individual nanorobotic units work together to change the shape of a larger extensible unit on demand. Since aggregate CNR function is integrated with the process of structural transformation, the utility of the transformable structures vary with each sequence of change of the process. In this sense, individual nanorobots are a form of artificial “synthetic stem cells” that are used to form various specific topological structures on demand. The biodynotics CNR system may be used on the surfaces of larger inert objects to change their structure.

Conceive of this process as a set of tiny Lego's that fit together and, upon specific stimuli, disassemble and reassemble into new configurations of pieces. Unlike the artificial neural network hardware system, which has specific functionality, this system is primarily extensible and emphasizes the transformation of physical structure.

To add an analogy from nature, this process is similar to the folding and malleability of peptides to create specific protein functions. By using a database of combinatorial chemistry and a catalogue of protein structures, researchers are able to identify the purposes of specific classes of proteins as well as their optimum range of conditions. Similarly, collective nanobiodynotics systems will be used for creating transformable geometric structures to enter an object, transform to perform specific functions, and then retransform in order to exit the object. These complex synthetic processes emulate natural transformable functions. The numerous applications of this system will be discussed below in the context of biology, medicine and security.

One of the advantages of configuring collectives of nanorobots in biodynotics is to facilitate a novel concept of intelligent self-assembly. For instance, sets of individual nanoparts may be allowed to fit into constricted space and then automatically self-configure into usable whole entities with specific functionality in order to solve a problem. This is a nano-scale version of the analogy of getting big parts through a narrow doorway and then reassembling them in a bigger room.

Another advantage of collective nanobiodynotics is the use of redundancies in CNR networks in order to emulate biological processes such as the immune system. This model provides a failsafe process to accomplish a task.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

### DESCRIPTION OF THE DRAWINGS

FIG. 1 is a diagram showing groups of nanorobots.

FIG. 2 is a schematic diagram showing the process of combining two sets of nanorobots.

FIG. 3 is a diagram showing several phases in a process of changing configurations of nanorobots.

FIG. 4 is a diagram showing the addition of nanorobots to an assembly of nanorobots.

FIG. 5 is a schematic diagram showing the changing configuration of overlapping assemblies of nanorobotic collectives in two phases.

FIG. 6 is a schematic diagram illustrating the changed configuration of a collective of nanorobots as it interacts with a changing environment.

FIG. 7 is a schematic diagram showing the integration of two groups of nanorobots over three phases.

FIG. 8 is a schematic diagram showing the process of the removal of nanorobots in one group by the nanorobots in another group over several phases.

FIG. 9 is a diagram showing the reconfiguration of artificial proteins using collectives of nanorobots over three phases.

FIG. 10 is a flow chart describing the process of reconfiguration of a collective of nanorobots.

FIG. 11 is a diagram showing the common core of a device that has changing configurations of nanorobotic collectives in three phases.

FIG. 12 is a flow chart describing the reconfiguration process of a nanorobotic collective.

FIG. 13 is a chart that shows the use of metaheuristic systems by collectives of nanorobots.

### DETAILED DESCRIPTION OF THE DRAWINGS

One of the chief attributes of evolvable hardware composed of collectives of nanorobots or microrobots is the ability to aggregate into specific configurations and then to reaggregate into different configurations. This ability to reaggregate physical structure on-demand provides a new application of social intelligence. In the case of nanorobotics and microrobotics, each robot has intelligence capabilities because of on-board integrated circuitry that computationally processes solutions to problems. When linked to other nanorobotic or microrobotic entities, the collectives of nanorobots and microrobots display active social intelligence that modifies extensible spatial position of the combined agents.

The following description of the drawings illustrates the organization and reorganization processes of collectives of nanorobots. The drawings also apply to microrobots.

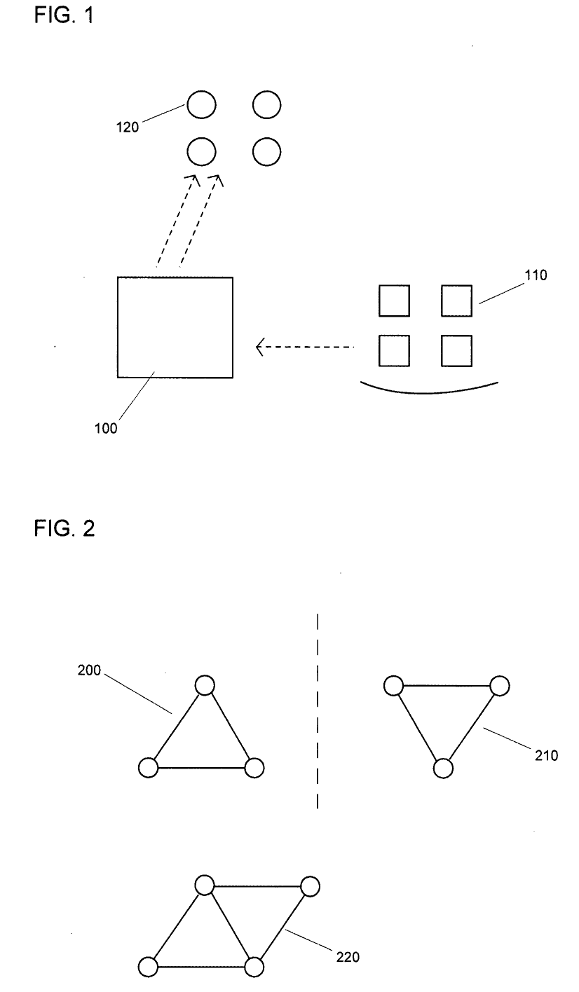

FIG. 1 shows a collective of nanorobots (110) that moves location to combine into a new structure at a new location (100) and then to disaggregate into new separate structures (120) at another location.

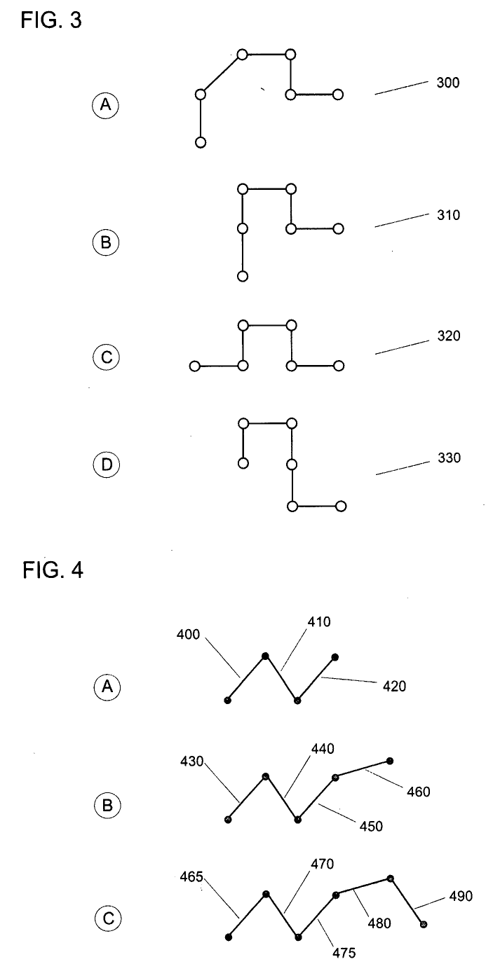

FIG. 2 shows two triangular groups of nanorobots (200 and 210) that combine to form one contiguous assembly (220). FIG. 3 shows four phases of the reconfiguration of group of nanorobots from A to B, from B to C and from C to D. This changed composition of the group of nanorobots resembles a collection of Legos that shift the angles of the connections as new units are added or removed. This drawing shows the self-assembly process of a collective of nanorobots.

FIG. 4 shows three phases of the addition of new nanorobots to new positions to the right of the initial group of three nanorobots (400, 410 and 420) at A. The connection (460) is added at phase B, while the additional connection (490) is added at phase C. This drawing shows the building out process as a nanorobotic collective changes composition by adding nanorobots to a specific assembly.

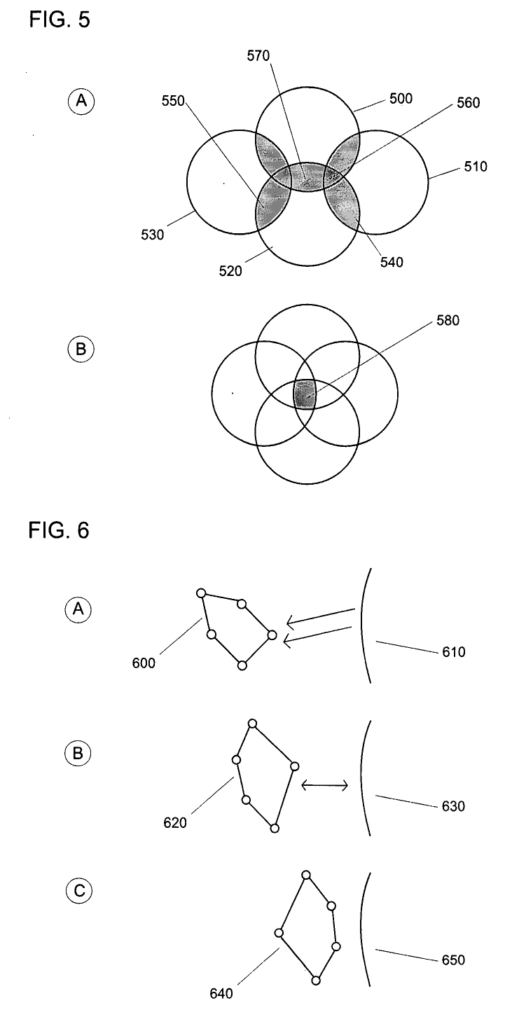

FIG. 5 shows two sets of overlapping circles. In the initial position of phase A, the central position (570) is shown, while as the circles change positions to move closer together, the central position (580) at phase B is more compressed.

FIG. 6 shows the process of changing configuration of a collective of nanorobots as it interacts with its environment. At phase A the nanorobotic collective (600) receives feedback from the environment (610) to which it reacts by reorganizing its physical structure (620) at phase B. The collective of nanorobots continues to interact with its environment (630), which has itself changed. This interaction has caused the collective of nanorobots (640) to change its physical configuration again at phase C as it interacts with a changed environment (650). This process continues until the collective of nanorobots has achieved its mission.

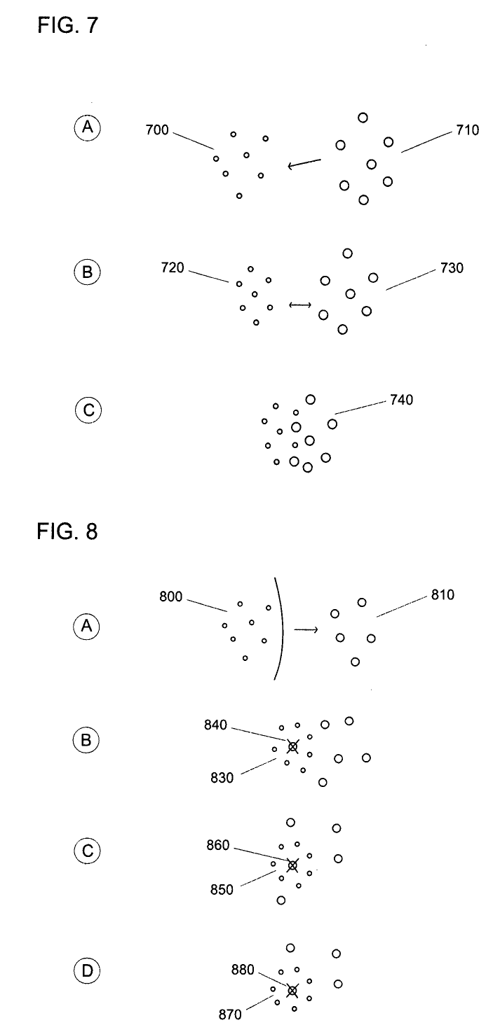

In FIG. 7, the interaction process of groups of nanorobots in shown. At phase A, the smaller nanorobots (700) interact with the larger nanorobots (710). At phase B, the two groups (720 and 730) of nanorobots are attracted to move closer to each other. Finally, at phase C, the two groups intermingle (740). This process of integration is critical to the self-assembly process. It resembles the integration of chemical structures in a chemical reaction as compatible chemicals reorganize their structures.

FIG. 8 shows several phases in which a collective of nanorobots attacks and destroys nano-objects. In phase A, the collective of nanorobots (800) moves towards the nano-objects (810). The first nano-object that is identified (840) is surrounded by the collective of nanorobots (830) at phase B. At phase C, another nano-object (860) is identified and surrounded by the nanorobotic collective (850). This step is repeated until all of the nano-objects are destroyed. This process is useful to defeat pathogens. It is also for groups of nanorobots to attack and defeat other groups of nanorobots by employing complex game theoretic strategies.

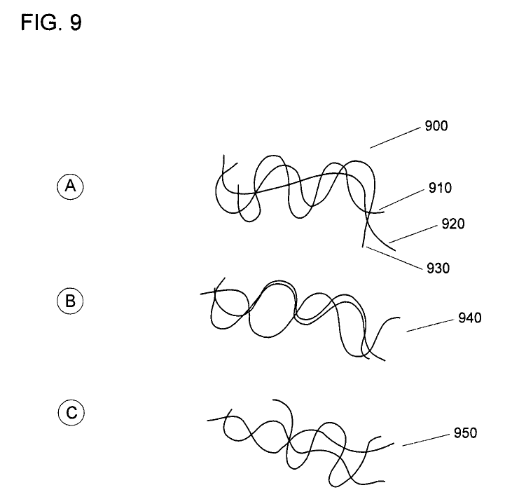

FIG. 9 shows the several phases of the reconfiguration of an artificial protein. At phase A, the strands of the artificial protein, which are constructed of assemblies of nanorobots, are organized into a specific structure. This initial structure transforms at phase B and again at phase C.

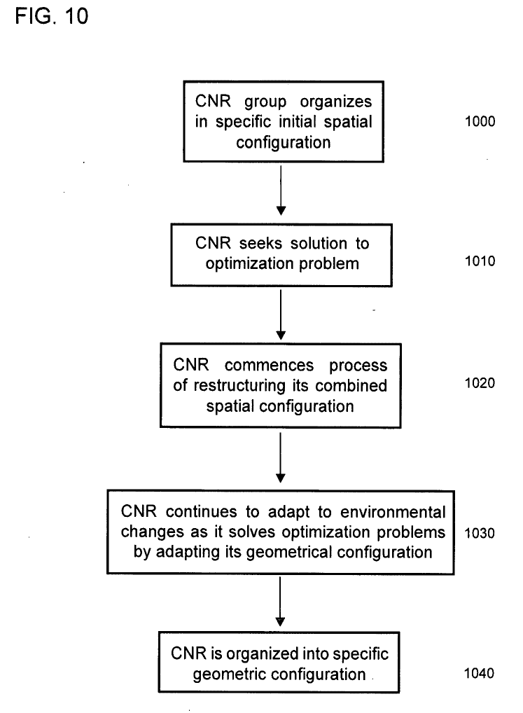

The process of reaggregation of collectives of nanorobots is described in FIG. 10. After the CNR group organizes in a specific initial spatial configuration (1000), it seeks a solution to an optimization problem (1010). The CNR commences the process of restructuring its combined spatial configuration (1020) and continues to adapt to environmental changes as it solves optimization problems (1030) by adapting its geometrical configuration. The CNR is then organized into a specific geometrical configuration.

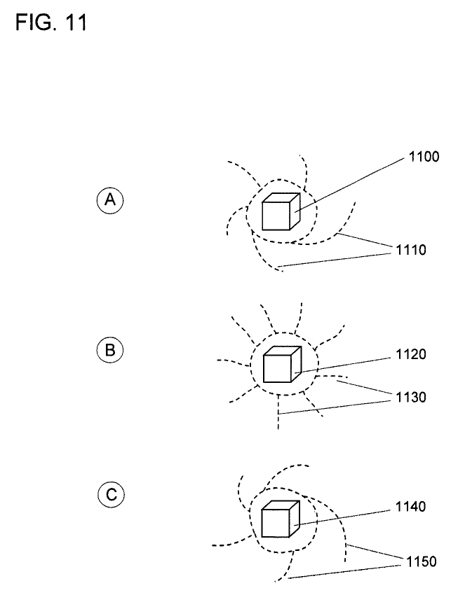

FIG. 11 shows three phases in the changing process of CNRs. In this drawing, at phase A, the core (1100) has a collective of nanorobots (1110) on its surface in a specific configuration. The configuration of the nanorobots (1130) changes it position at phase B, while the common core apparatus (1120) has not changed position. Similarly at phase C, the nanorobotic collective (1150) has changed its configuration on the surface of the apparatus (1140), which retained its position.

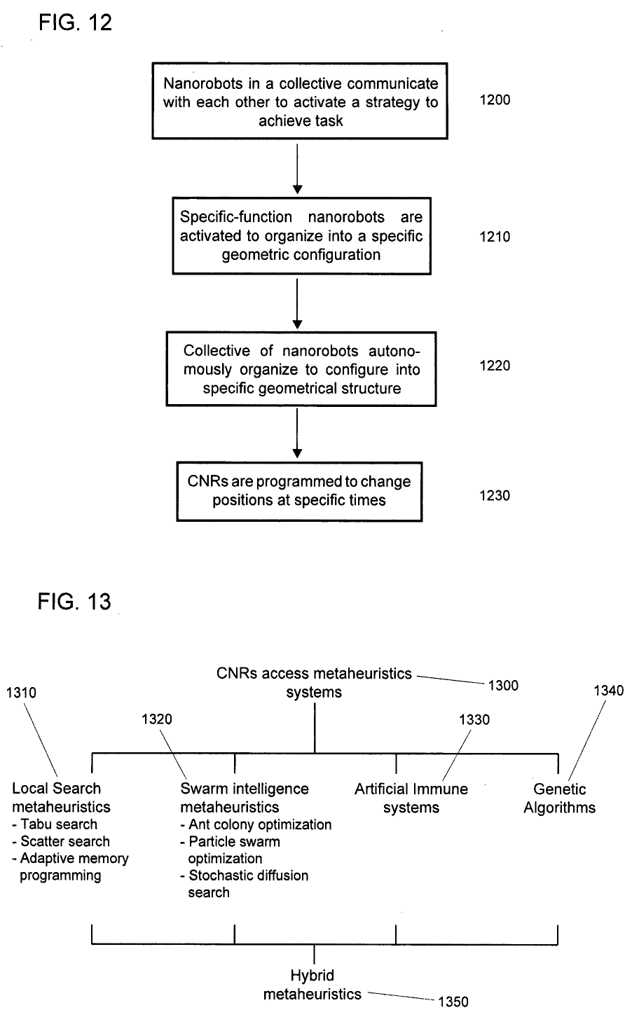

FIG. 12 describes the process of organizing a collective nanobiodynotic algorithm. After the nanorobots in a collective communicate with each other to activate a strategy to achieve a task (1200), the specific-function nanorobots are activated to organize into a specific geometric configuration (1210). The collective of nanorobots then autonomously organize to configure into specific geometrical structure (1220). The CNRs are programmed to change their geometric positions at specific times (1230).

In FIG. 13, a table shows the different main metaheuristics systems that are employed by the nanorobotics system. The main metaheuristics models are local search, swarm intelligence, artificial immune systems and genetic algorithms. These metaheuristics systems each have several main types and hybrids, which are selectively chosen by the collective of nanorobots in order to perform social behaviors.

What is claimed is:

1. A system for managing aggregation of a collective of nanorobots (CNRs), comprising:
A plurality of nanorobots, each nanorobot including program code configured to communicate and exchange information with other nanorobots;
A plurality of sets of nanorobots;
Control logic configured to control formation of the plurality of nanorobots into a plurality of configurations in response to external stimulus;
Wherein each set of nanorobots in a CNR is organized into specific spatial configuration by cooperating nanorobot behaviors;
Wherein the specific spatial configuration of each set of nanorobots in the CNR is based on information in the environment.

2. A system for managing a collective of nanorobots (CNRs), comprising:
A plurality of nanorobots that function collectively as a network;
Wherein the network collects information about the environment;
Wherein the information is shared between the nanorobots in the CNR;
Wherein the information is divided between the nanorobots;
Wherein the information is analyzed by the nanorobots;
Wherein the nanorobots cooperate in making a decision and generate instructions on how to proceed;
Wherein the instructions are provided to member nanorobots in the CNR; and
Wherein the nanorobots are organized into specific configurations based on the instructions in order to interact with the environment.

3. A system for managing automated collective nanorobots (CNRs), comprising:
A plurality of nanorobots, each nanorobot including program code configured to communicate and exchange information with other nanorobots;
Wherein the nanorobots in a CNR work together to obtain information from the environment and to cooperatively make decisions on collective behavior;
Wherein the nanorobots configure into specific sets to achieve the strategies specified by the collective;
Wherein the nanorobots receive new information from the environment;
Wherein the nanorobots receive new instructions from an external computer by communications input;
Wherein the nanorobots analyze the new information about the environment and the new instructions and determine a new course of action;
Wherein sets of nanorobots in the CNR restructure their physical geometric structure into new configurations;
Wherein the CNR solves multiple objective combinatorial optimization problems as it continuously reorganizes within a changing non-deterministic environment; and
Wherein the CNR continuously self-assembles into different configurations.
